(19) United States
(12) Patent Application Publication
(10) Pub. No.: US 2026/0166825 A1
(43) Pub. Date: Jun. 18, 2026

(54) A STERILE CONTACT LENS 3D PRINTING METHOD AND DEVICE

(71) Applicant: Edan KENIG, RAMAT HASHARON (IL)

(72) Inventors: Edan KENIG, RAMAT HASHARON (IL); Arie Oscar HOLTZ, Jerusalem (IL)

(21) Appl. No.: 18/707,788

(22) PCT Filed: Nov. 23, 2022
(86) PCT No.: PCT/IL2022/051249

§ 371 Date: May 6, 2024

(30) Foreign Application Priority Data
Dec. 6, 2021 (IL) 288719

(51) Int. Cl. B29D 11/00; B29C 64/129; B29C 64/30; B29C 64/386; B29C 71/00; B29L 11/00; B33Y 10/00; B33Y 30/00; B33Y 40/00; B33Y 50/00; B33Y 80/00

(52) U.S. Cl. CPC B29D 11/00067; B29C 64/129; B29C 64/30; B29C 64/386; B29C 71/0009; B29D 11/0025; B33Y 10/00; B33Y 30/00; B33Y 40/00; B33Y 50/00; B33Y 80/00; B29C 2071/0045; B29L 2011/0041

(57) ABSTRACT

The present invention relates to a device, for the sterile 3D printing of a contact lens, comprising: (a) at least 0.2 ml of photopolymer resin, which solidifies upon transmission from a light source; (b) a receptacle, for containing said photopolymer resin, having a transparent bottom, for allowing an external light source to transmit light into said device for selectively solidifying part of the photopolymer resin into a solidified polymer layer of said contact lens; (c) a detachable top, for covering said receptacle, with an aperture for allowing the flow of fluids into and out of said device; (d) an elevatable platform, located inside said device, serving as a build plate for the solidified layer(s) of said contact lens and (e) a conduit, attached to said platform and accessible from without said device, for allowing the flow of fluids into and out of said device.

### Technical Field

The present invention relates to field of contact lens 3D printing. More particularly, to the sterile 3D printing and packaging of a sterile contact lens.

### BACKGROUND

As of today, there are more and more patients with vision problems, e.g. refractive errors, such as myopia, astigmatism, and other corneal abnormalities such as keratoconus. While glasses may be a solution for such refractive errors, many patients choose contact lenses due to their aesthetic and convenient features.

Disposable contact lenses, especially daily disposable modality, provides an excellent solution for vision correction, as they enable sharp vision, comfort, are maintenance free and pose lower risk of infection. However, due to current manufacturing techniques, daily disposable lenses aren't available for patients who need them the most, those with outlier prescriptions such as combinations of high myopia, astigmatism and presbyopia, or ocular surfaces irregularities for example keratoconus. These patients, unfortunately, do not have many options, one of which is to settle for a reusable and expensive solution as they cannot find other readily available and affordable personalized solutions.

Three common techniques are used today for manufacturing soft contact lenses. These are generally referred to as 1. lathing-cutting both lens surfaces and edge on an anhydrous gel cylindrical ‘button’ that may follow by hydration if necessary; 2. spin casting—using a single concave mold piece to form the front surface of the lens; and 3. cast molding—using a concave mold piece to form the front surface of the lens and a second convex mold piece to form the back surface of the lens.

Lathing is a suitable process where there is a low batch size and a wide variety of lens powers and/or designs required, e.g. for toric lens manufacturing. Spin casting is a suitable process for higher batch sizes, however, the ‘open’ surface not being in contact with a mold will be parabolic this being a ‘compromise’ profile to the generally spherical lenses. Cast molding is a suitable for very high-volume manufacturing and facilitates the precise profiling of both the front (by the concave mold surface) of the lens and back surface (by the convex mold surface) of the lens e.g. creating a bi-curve or even a tri-curve profile for optimum cornea fit. Nevertheless, the contact lenses, mass produced by the above methods, are typically unable to address individual needs and personalization.

Fortunately, 3D printing technology has improved in the past years. 3D printing typically refers to making complex 3D objects from a Computer-Aided Design (CAD) model. In many cases the digital design model is first parsed into layers and then the 3D printing is performed using the technical principle of “additive manufacturing, layer by layer”, which is basically the accurate 3D stacking of materials. Thus, 3D printing technology can be used for creating contact lenses that are specifically tailored to individual needs. Nevertheless, 3D printing of ready to use sterile contact lenses, is not yet prevalent.

Another problem is the packaging of these 3D printed contact lenses. An inferior packaging of the printed contact lens may compromise the sterilization of the contact lens and render it inadequate for use. There are three basic contact lens packaging systems used today: a glass vial with bung and metal clip closure; a plastic ‘mold-cup’ with metallized aluminum foil seal; and an integrated plastic ‘mold-cup’ where one of the mold pieces used to form a cast lens is also used as the packing container generally sealed with metallized foil.

In order to achieve a healthier eyecare regiment it is advised of frequent lens replacement, e.g. monthly, bi-weekly or daily replacement, however this necessitates the low cost of lens fabrication and packaging. Daily disposable contact lenses are recognized as the healthiest modality of contact lens wear. However, to meet the wearer's requirement, for as many as 730 contact lenses per year, requires extremely low unit cost whilst ensuring high quality lens fabrication and high levels of on-eye comfort and visual acuity. While this is available with mold mass manufacturing, patients with outlier prescriptions can only relay on 3D printing for the customization and manufacturing of their personalized prescriptions.

In summary, there is a need for a method for the 3D printing of contact lenses that can tailor a contact lens to suit individual needs and personalize the contact lens based on patients'front eye surface scans, that are typically available to patients from standard instrumentation. e.g. corneal topographer, that is readily available today in the clinics of eye care professionals around the world, while being cost effective.

CN104827671 discloses a method for 3D printing of a contact lens, comprising the following steps: Step S1, a 3D data scanner establishes a wearer's personal eyeball model, and scans a patient's eyeball through a 3D data scanner and other medical measuring instruments to obtain eyeball model data; Step S2, the eyeball model data in step S1 is three-dimensionally modeled by the computer, and the three-dimensional model of the 3D contact lens to be printed is stored in the computer; step S3, the printing condition and the requirement setting, according to the eyeball model data of step S1Setting the degree of myopia, astigmatism, transmittance, and curvature of the lens; in step S4, the computer establishes a connection with the printer, so that the computer controls the lifting platform of the 3D printing machine; step S5, preparation of the printing material, and adding to the 3D printer; step S6, the 3D printer controls the preparation of the contact lens; step S7,freeze forming, and immediately printing the cured product by cold trap freezing; step S8, subsequent processing: performing the surface of the formed contact lens product Polished and burred. However, the publication does not describe a method for manufacturing ready for use lens.

US2019111640A1 discloses a method for the manufacture of a contact lens, the method comprising providing a first, concave, mold-half having a first concave mold surface to correspond with a convex surface of the contact lens; providing a second, convex, mold-half having a second convex mold surface to correspond with a concave surface of the contact lens, said second mold half configured to engage with the first mold-half to define a first, pre-cure, mold cavity therebetween, which mold cavity is defined by the first, concave, mold surface and second, convex, mold surface said first and second mold surfaces having respective curvatures to correspond with a pre-determined lens power/curvature and wherein the first or second mold surface is defined by an annular ridge formed on the respective mold half; disposing into the mold cavity a curable lens-forming fluid composition; curing said composition to form a pre-hydrated lens; and separating the first and second mold halves, characterized in that the engagement between the mold halves is unconstrained and at least one mold half is sufficiently pliable such that during the curing of said composition the first and/or second mold halves move relative to one another and/or flex such as to define between the first and second mold surfaces a second, post-cure, mold cavity, which second post-cure mold cavity defines a smaller volume than said first pre-cure mold cavity. Nevertheless, the disclosed method is not suited for customization.

It would therefore be desired to propose a system void of these deficiencies.

### SUMMARY

It is an object of the present invention to provide a method for an affordable and sterile production of personalized contact lenses.

It is another object of the present invention to provide a method for the sterile 3D printing and packaging of a personalized contact lens.

It is another object of the present invention to provide a device that is sterile, disposable, and cost effective for producing and storing a contact lens.

It is still another object of the present invention to provide a method for producing a tailored contact lens for patients with unique ocular topographies and outlier prescriptions.

It is still another object of the present invention to provide means for producing a contact lens that is based on a patient's front eye surface scans from available standard instrumentation.

Other objects and advantages of the invention will become apparent as the description proceeds.

The present invention relates to a device, for the sterile 3D printing of a contact lens, comprising: (a) at least 0.2 ml of photopolymer resin, which solidifies upon transmission from a light source; (b) a receptacle, for containing said photopolymer resin, having a transparent bottom, for allowing an external light source to transmit light into said device for selectively solidifying part of the photopolymer resin into a solidified polymer layer of said contact lens; (c) a detachable top, for covering said receptacle, with an aperture for allowing the flow of fluids into and out of said device; (d) an elevatable platform, located inside said device, serving as a build plate for the solidified layer(s) of said contact lens, wherein said platform elevates said solidified layer(s), of said contact lens, for allowing the solidification of a new layer, of said contact lens; and (e) a conduit, where the distal side, of said conduit, is attached to said platform and its proximal side is accessible from without said device, through said aperture in said top, for allowing the flow of fluids into and out of said device and for the elevating of said platform by pulling said conduit and the attached said platform.

Preferably, the printed contact lens is made of hydrogel, silicon hydrogel, bio-ink, or GP material.

Preferably, the light source is one of the following: a DLP projector, a LED Array, a Laser, or 2 photon polymerization.

Preferably, the platform has an aperture at its center under the conduit.

Preferably, the aperture is sealed by a removable cover.

Preferably, the contact lens is 3D printed according to a CAD model.

Preferably, the conduit has snap hooks for locking to the detachable top.

Preferably, there are holes at the sides of the conduit, for allowing the process of waste disposal.

Preferably, the device further comprises a cover for sealing the device. Preferably, the device is also used for packaging the contact lens.

Preferably, the receptacle has an opaque side, for protecting said photopolymer resin from ambient light.

The present invention also relates to a method, for the sterile 3D printing of a contact lens, comprising: (a) providing at least 0.2 ml of photopolymer resin, which solidifies upon transmission from a light source; (b) providing a receptacle, for containing said photopolymer resin, having a transparent bottom, for allowing an external light source to transmit light into said device for selectively solidifying part of the photopolymer resin into a solidified polymer layer of said contact lens; (c) providing a detachable top, for covering said receptacle, with an aperture for allowing the flow of fluids into and out of said device; (d) providing an elevatable platform, located inside said device, serving as a build plate for the solidified layer(s) of said contact lens, wherein said platform elevates said solidified layer(s), of said contact lens, for allowing the solidification of a new layer, of said contact lens; (e) providing a conduit, where the distal side, of said conduit, is attached to said platform and its proximal side is accessible from without said device, through said aperture in said top, for allowing the flow of fluids into and out of said device and for the elevating of said platform by pulling said conduit and the attached said platform; and (f) transmitting light into said device for solidifying part of the photopolymer resin into a solidified polymer layer, layer after layer, for forming said contact lens.

Preferably, the contact lens is inspected using at least one camera, to ensure the quality of the contact lens.

Preferably, the contact lens is washed by Buffered Saline or alcohol.

Preferably, a preservation solution is added to the receptacle for preserving the contact lens.

### BRIEF DESCRIPTION OF THE DRAWINGS

The accompanying drawings, and specific references to their details, are herein used, by way of example only, to illustratively describe some of the embodiments of the invention.

In the Drawings:

FIG. 1 is a diagram of the device, for the sterile 3D printing of a contact lens, from an isometric upper view, according to an embodiment of the invention.

FIG. 2 is a diagram of the device, for the sterile 3D printing of a contact lens, from an isometric upper view, without the side of the receptacle of the device, for the sake of brevity, according to an embodiment of the invention.

FIG. 3 is a diagram of the device, form an isometric lower view, without the side of the receptacle of the device, for the sake of brevity, where a first layer has been printed, according to an embodiment of the invention.

FIG. 4 is a diagram of the device, form an isometric lower view, without the side of the receptacle of the device, where the elevatable platform has been pulled, according to an embodiment of the invention.

FIG. 5 is a diagram of the device, form an isometric upper view, without the side of the receptacle of the device, with the 3D printed contact lens, according to an embodiment of the invention.

FIG. 6 is a diagram of the device, from an isometric upper view, without the side of the receptacle of the device, with the detached 3D printed contact lens, according to an embodiment of the invention.

FIG. 7 is a diagram of the device, from an isometric upper view, with the 3D printed contact lens produced and packaged, within the device, according to an embodiment of the invention.

### DETAILED DESCRIPTION

The terms of “front”, “rear”, “down”, “up”, “bottom”, “under”, “upper”, “over”, “horizontal”, “vertical”, “right”, “left” or any reference to sides or directions are used throughout the description for the sake of brevity alone and are relative terms only and not intended to require a particular component orientation.

Some of the known prior art 3D printing techniques are termed as “vat photopolymerization” which include several different processes that rely on the same basic strategy: a photopolymeric resin, contained in a vat. i.e. tank, that is selectively cured by a light source in order to form a solid layer. Thus, by stacking layer on layer a 3D physical object is built until completion. The light source may be a laser, LED Projector or array, with wavelengths ranging typically from 300 to 400 nm, a LCD, or any other known source for selectively curing the photopolymer resin. Nevertheless, the use of traditional vat photopolymerization for manufacturing a contact lens has several disadvantages. First, in a typical vat photopolymerization there is a contact of resin with parts of the printing machine such as conduits, printing platform, i.e. build platform, etc. where all these parts need to be sterilized and cleaned in-between uses, and the residual resin left in these parts needs to be discarded. Any residual resin left in the parts of the printing machine may be subjected to contamination and corrosion, which compromise the sterilization of the produced contact lens. Second, during the printing process, the photopolymer resin in the vat, and/or the residual resin in the parts of the printer, may be susceptible to small amounts of unintentional curing and may be oxidized, contaminated and degraded. Thus, the quality of the photopolymer resin may be slightly compromised which may hamper the ability to precisely control the outcomes of the 3D printed object. Although a small quality degradation, of the photopolymer resin in a typical vat photopolymerization 3D printing, may not be problematic, when dealing with an optical device, especially medical device such as a contact lens, which is placed directly on the eye, preserving initial quality and curing characteristics of the photopolymer resin is paramount. Furthermore, to keep high quality and save costs, the waste of material, such as the photopolymer resin, must be kept to minimum during the production of the contact lens. For example, instead of using 150-200 ml of photopolymer resin, in a typical vat photopolymerization 3D printing, the proposed system can use about 0.2-2 ml of photopolymer resin. Thus, a device is required that can be used to print a contact lens while all the parts of the device that interact with the resin can be disposable and replaceable, while being cost effective and sterile.

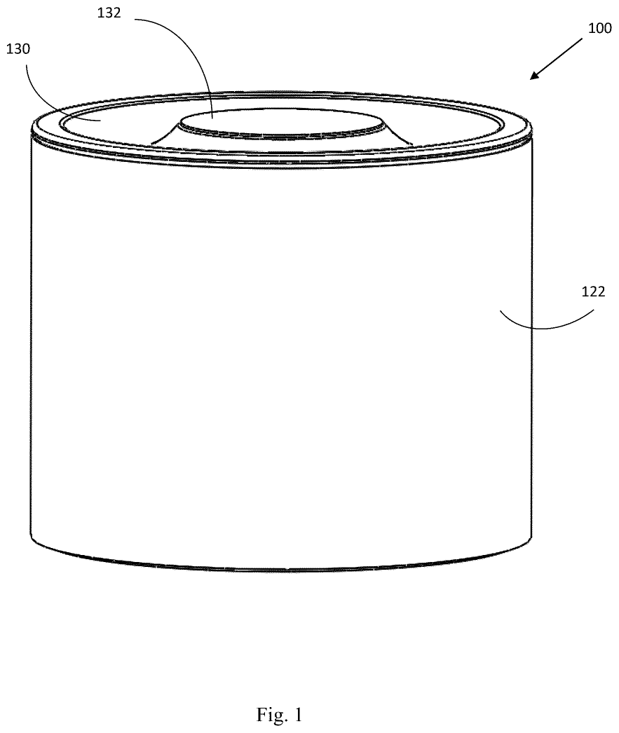

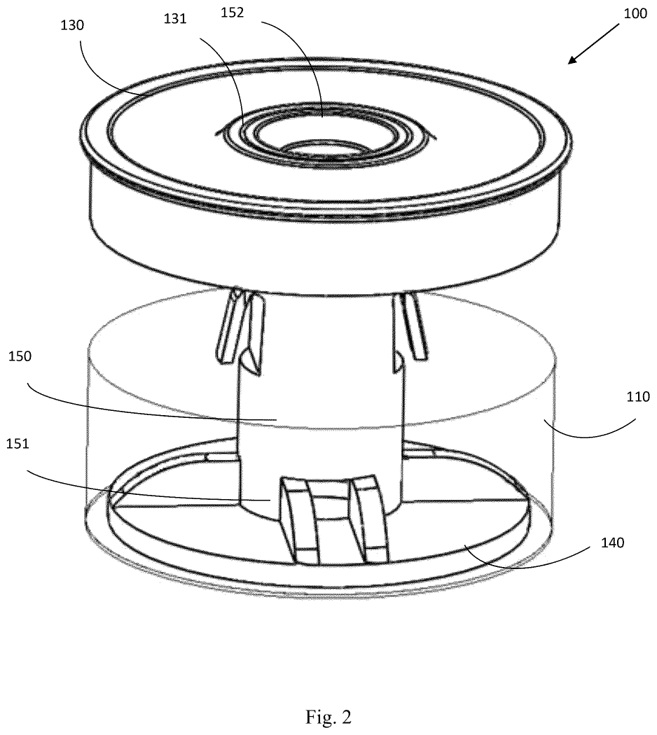

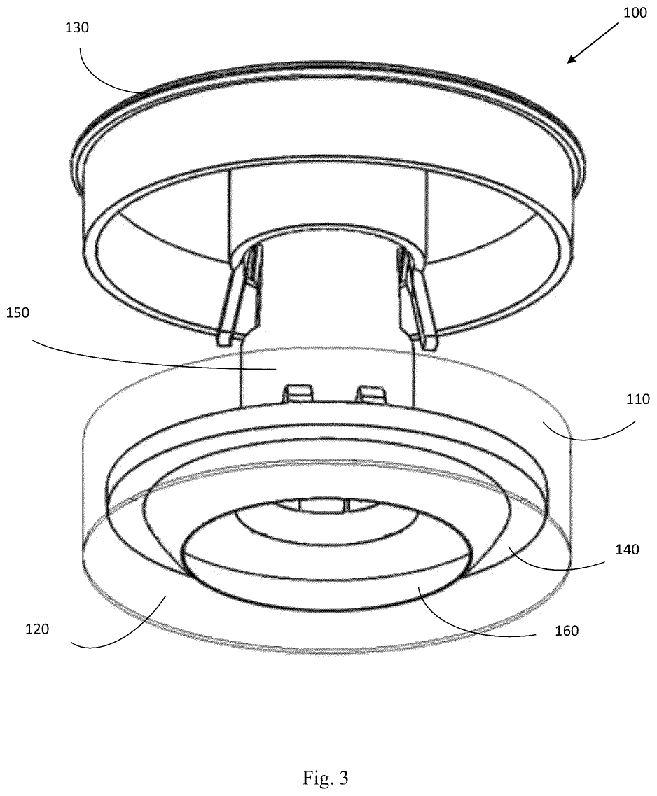

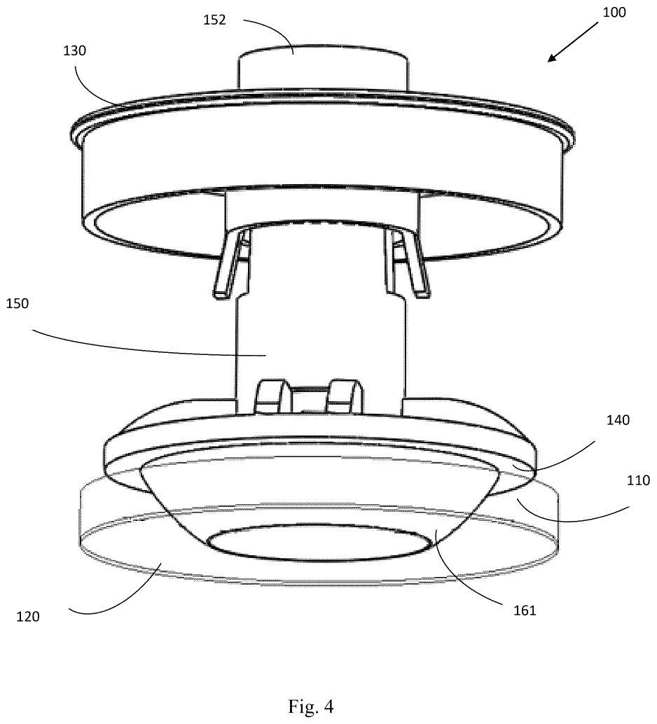

FIG. 1 is a diagram of the device, for the sterile 3D printing of a contact lens, from an isometric upper view, according to an embodiment of the invention. The device 100 may be sterilely preloaded with at least 0.3 ml of photopolymer resin. In one embodiment, the device 100 may be preloaded with at least 0.5 ml of photopolymer resin. In one embodiment, the device 100 may be preloaded with less than 2.5 ml of photopolymer resin. The photopolymer resin may comprise a formulation for the creation of Hydrogel or Silicone Hydrogel or RGP (Rigid Gas-Permeable) materials, bio-ink, or even hybrid contact lenses or any other resin that cures and hardens into a solidified optically transparent, oxygen permeable Biocompatible matrix upon exposure, e.g. transmission, from a light source. In some embodiment the photopolymer resin may comprise several key ingredients such as monomers: HEMA/MMA/TRIS—or similar, photoinitiators: irgacure 819, TPO,—or similar, crosslinker: EGDMA—or similar, ascorbic acid as a quencher—or similar ingredients. The light source may be a DLP (Digital Light Processing) projector, Led Array, Laser, 2 photon polymerization, or any other light source used to solidify a photopolymeric resin. Thus, a contact lens can be constructed within the device 100, layer by layer, by selectively exposing the resin in the device 100 to a light source, layer upon layer, as will be described later in FIG. 4. The device 100 may have a receptacle 122, for containing and protecting the photopolymer resin. The receptacle 122 may have an opaque side(s), for protecting the photopolymer resin from any ambient light in order to avoid resin degradation. The receptacle 122 has a transparent bottom for allowing to selectively solidify areas of the contained photopolymer resin by an external light source. In one embodiment, the opaque sides of the receptacle 122 are made to prevent ambient light that may comprise the quality of the resin. For example, if the photopolymer resin is UV curable—the sides of the receptacle can be made of materials that are UV filters and/or UV blockers to prevent the penetration of UV light that may unselectively solidify and damage the resin. The receptacle may also have a transparent bottom, as shown for example in FIG. 3, for allowing an external light source to selectively transmit light into said receptacle, from under the device. The external light source can thus cure parts of the photopolymer resin into a solidified polymer layer of a contact lens. In one embodiment the transparent bottom may have an opaque removable cover (not shown). The device 100 may also have a detachable top 130, for covering the receptacle 122. In one embodiment, the detachable top 130 has an aperture at its center, as shown for example in FIG. 2, for allowing the flow of fluids into and out of the device in order to accommodate washing out resin residues and hydration of the created hydrogel and dispensing the finalized product. In some embodiments the aperture may be sealed by a removable cover 132 which may also be useful as a label for the personalized contact lens. The removable cover 132 may be punctured or removed prior to use.

FIG. 2 is a diagram of the device, for the sterile 3D printing of a contact lens, from an isometric upper view, without the side of the receptacle of the device, for the sake of brevity, according to an embodiment of the invention. The device 100, as described in relations to FIG. 1, is preloaded with photopolymer resin 110. The device 100 also has an elevatable detachable platform 140. The elevatable platform 140, located inside the receptacle, may serve as a turned over single use disposable build plate for the solidified layer(s) of a contact lens during the 3D printing process. The elevated platform 140 is attached to a conduit 150, to allow the elevation of the platform 140 by pulling the conduit 150 and the attached platform 140. The device 100 itself may be held in place using an external manipulator, gripper, turn lock, bayonet connector, or any other known method while the conduit 150 and the attached platform 140 are pulled up. In one embodiment the distal side 151, of the conduit 150, is attached to the center of the platform 140 and the proximal side 152, of the conduit 150, is accessible from without the device, through the aperture 131 in the top 130 of the device 100. Thus, when the proximal side 152 of the conduit 150 is pulled up, by an external mechanism, such as a protruding spring tooth, or by attaching a metallic washer like ring at the top and pulling it with an electromagnet, the attached elevated platform 140 is also pulled up. In one embodiment, the aperture 131, in the top 130, may have a lower peripheral margin, as shown for example in FIG. 3, for minimizing the wobbling when the conduit 150 is pulled up. In one embodiment, the platform 140 has an aperture at its center under the conduit, as shown for example in FIG. 3, for allowing the flow of fluids. Thus, the conduit 150 may be used for allowing the flow of fluids into and out of said device.

FIG. 3 is a diagram of the device, from an isometric lower view, without the side of the receptacle of the device, for the sake of brevity, where a first layer has been printed, according to an embodiment of the invention. As described in relations to FIG. 1, the receptacle of the device may have a transparent bottom 120 for allowing an external light source to selectively transmit light into said receptacle. An external light source can thus selectively transmit light through the transparent bottom 120 and solidify parts of the photopolymer resin into a solidified polymer layer 160, of a contact lens, on the bottom of the elevatable platform 140. For example, an external light source such as a DLP projector can transmit light from under the device 100 and solidify for example a ring like layer of 15 mm on the platform 140, which can serve as the first layer of a printed contact lens.

FIG. 4 is a diagram of the device, from an isometric lower view, without the side of the receptacle of the device, where the elevatable platform 140 has been pulled up, according to an embodiment of the invention. As described in relations to FIG. 3, the receptacle of the device has a transparent bottom 120 for allowing an external light source to selectively transmit light into said receptacle. Thus, an external light source can selectively transmit light in the appropriate wavelength through the transparent bottom 120 and solidify parts of the photopolymer resin into a solidified polymer layer of the fabricated contact lens. As shown, the platform 140 can be pulled upwards by pulling the proximal side 152 of the conduit 150 thus allowing the external light source to continue and solidify additional part of the photopolymer resin into another solidified polymer to form adjacent layer 161 of the contact lens. Thus, the platform 140 can be pulled upwards again and again while each time a new layer may be solidified on top of a former solidified polymer layer, for forming the complete contact lens structure.

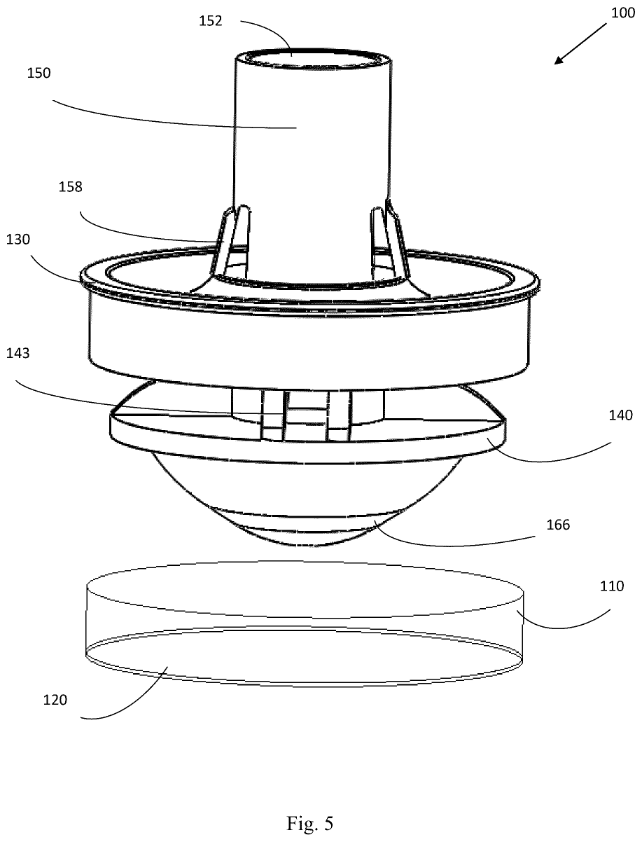

FIG. 5 is a diagram of the device, from an isometric upper view, without the side of the receptacle of the device, with the completed printed contact lens, according to an embodiment of the invention. As described in relations to FIG. 4, an external light source can selectively transmit light through the transparent bottom 120 and solidify part of the photopolymer resin into a solidified polymer layer of a contact lens. The platform 140 can be pulled upwards after each layer has been solidified while each time a new layer may be solidified on top of a former layer until forming the complete contact lens 166. In one embodiment, the forming the complete contact lens 166 is according to a CAD model which may be designed based on patient's cornea. As depicted, the conduit 150 may be lifted to a fully extended position, where it may lock to the detachable top 130, using snap hooks, such as snap hook 158, that may be located along the conduit 150, for example.

At this stage the device may be turned upside down for disposing the excess photopolymer resin 110, left after the printing of the contact lens, i.e. waste, to fall out through the conduit 152. In one embodiment there may be holes at the sides of the conduit, such as hole 143 shown in FIG. 5, for allowing the process of waste disposal once the distal side of conduit is blocked by the printed contact lens. Other methods and techniques may be used for waste disposal and sterile fluid replacement.

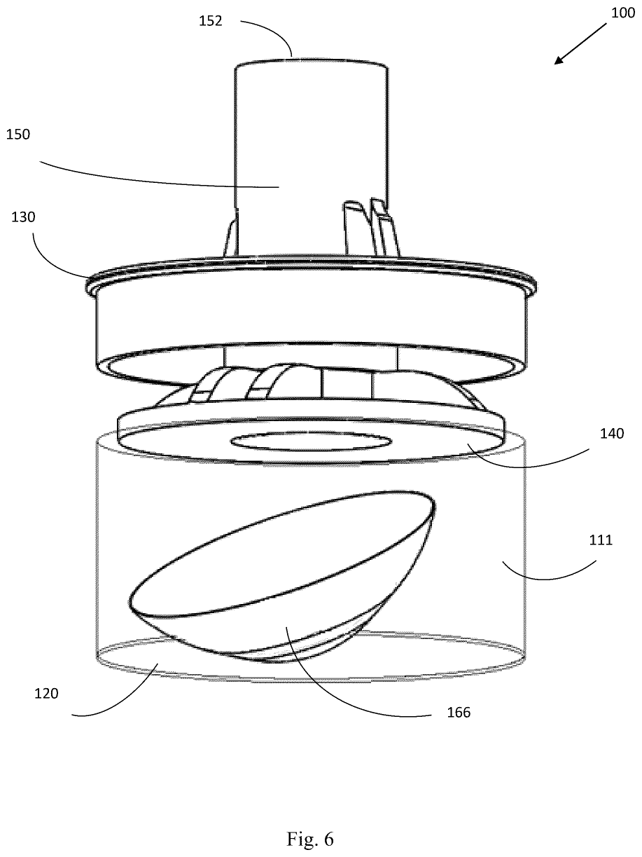

FIG. 6 is a diagram of the device, from an isometric upper view, without the side of the receptacle of the device, with the detached 3D printed contact lens, according to an embodiment of the invention. As described in relations to FIG. 5, an external light source can selectively transmit light through the transparent bottom 120 and solidify parts of the photopolymer resin, layer after layer, for forming the complete contact lens 166. After forming the contact lens 166, and while disposing the excess photopolymer resin, the contact lens 166 may be detached and washed for discarding any unwanted residues of the process that may be harmful to the eye. The detachment and washing may be done by pouring Buffered Saline, e.g. Phosphate buffered saline, EtoH (Ethanol) or any other known alcohol, through the conduit 150 into the device 100 and then flushing the fluids out through the conduit 150 by turning the device upside down. In some embodiment this process may be repeated more than once. In another embodiment, the detaching and washing may be done by pouring EtoH, or any similar cleansing liquid, through the conduit 150 into the device 150 and then flushing the fluids out through the conduit 150 by turning the device upside down. After washing with EtoH, the contact lens 166 may be washed again, for discarding residues of the EtoH, by pouring buffered saline, or other cleansing liquid, through the conduit 150 into the device 150 and then flushing the fluids out through the conduit 150 by turning the device upside down. At this stage the top 130, the platform 140, and its attached conduit 150, may be removed after washing and cleaning the contact lens.

In one embodiment, a hydrogel or silicone hydrogel contact lens may be formed by printing a precursor of the contact lens in the form of a xerogel, i.e. in anhydrous gel form. Once the xerogel contact lens precursor has been printed and detached in the device the xerogel contact lens may be hydrated by pouring hydration liquid PBS, or any other buffered aqueous solution, into the device. The contact lens may be hydrated until it swells to its final dimensions and water content.

In one embodiment, the photopolymer resin comprises bio-ink where a contact lens may be formed by solidifying part of the bio-ink in the receptacle of the device. In one embodiment, the used bio-inks are bio inks that support vat resin photopolymerization. These bio-inks consist of biological monomers such as proteins, e.g. Gelatin or collagen, or saccharides, e.g. agarose, coupled with a crosslinker and a photo-initiator. Thus the bio-ink can act as a resin and form a contact lens by selective solidification upon exposure to a light source. In many cases bio-inks may share many of the qualities of standard contact lens materials, such as oxygen permeability, and thus can play an important role in the printing of biological contact lens that are comfortable, and biodegradable.

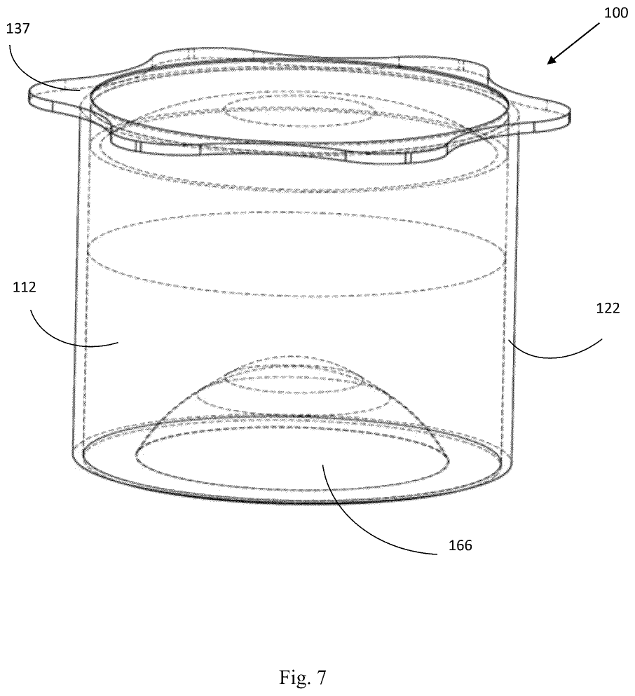

FIG. 7 is a diagram of the device, from an isometric upper view, with the printed contact lens produced and packaged, within the device, according to an embodiment of the invention. As described in relations to FIG. 6, a contact lens 166 may be printed and produced, within the device 100, and then it may be washed and cleaned within the device 100. The platform 140, and its attached conduit 150, may be removed after washing and cleaning the contact lens, as well. In one embodiment, a camera may be used to inspect the contact lens from the top, once the top 130 and the platform 140 have been removed. In one embodiment, several cameras, or a camera array system, may sample the product several times along the process, from top and/or from the bottom, to ensure the mechanical and optical quality of the contact lens. In one embodiment, a preservation solution 112, such as a mixture of PBS and antiseptic agent, may be added to the receptacle 122, for preserving the contact lens 166. At this stage, a cover, such as cover 137 may be pushed on top of the receptacle 122 of device 100, for sealing the device 100. In one embodiment, the cover 137 may be designed to tight fit the top part of a receptacle 122, for sealing the device 100.

In another embodiment, the cover 137 may be glued via UV curable glue, or any other known adhesive that may be used, to the top of receptacle 122, for sealing the device 100. The cover 137 may have a top made of a photosensitive or heat sensitive material that could be used to label the device with the user's details, prescription, modality, expiration date, and/or any other information required.

The device may be used for a resin 3D printing system or with a dedicated contact lens printing machine.

While the above description discloses many embodiments and specifications of the invention, these were described by way of illustration and should not be construed as limitations on the scope of the invention. The described invention may be carried into practice with many modifications which are within the scope of the appended claims.

1. A device, for the sterile 3D printing of a contact lens, comprising:
at least 0.2 ml of photopolymer resin, which solidifies upon transmission from a light source;
a receptacle, for containing said photopolymer resin, having a transparent bottom, for allowing an external light source to transmit light into said device for selectively solidifying part of the photopolymer resin into a solidified polymer layer of said contact lens;
a detachable top, for covering said receptacle, with an aperture for allowing the flow of fluids into and out of said device;
an elevatable platform, located inside said device, serving as a build plate for the solidified layer(s) of said contact lens, wherein said platform elevates said solidified layer(s), of said contact lens, for allowing the solidification of a new layer, of said contact lens; and
a conduit, where the distal side, of said conduit, is attached to said platform and its proximal side is accessible from without said device, through said aperture in said top, for allowing the flow of fluids into and out of said device and for the elevating of said platform by pulling said conduit and the attached said platform.

2. A device according to claim 1, where the printed contact lens is made of hydrogel, silicon hydrogel, bio-ink, or GP material.

3. A device according to claim 1, where the light source is one of the following: a DLP projector, a LED Array, a Laser, or 2 photon polymerization.

4. A device according to claim 1, where the aperture is sealed by a removable cover.

5. A device according to claim 1, where the platform has an aperture at its center under the conduit.

6. A device according to claim 1, where the contact lens is 3D printed according to a CAD model.

7. A device according to claim 1, where the conduit has snap hooks for locking to the detachable top.

8. A device according to claim 1, where there are holes at the sides of the conduit, for allowing the process of waste disposal.

9. A device according to claim 1, further comprising a cover for sealing the device.

10. A device according to claim 9, where the device is also used for packaging the contact lens.

11. A device according to claim 1, where the receptacle has an opaque side, for protecting said photopolymer resin from ambient light.

12. A method, for the sterile 3D printing of a contact lens, comprising:
providing at least 0.2 ml of photopolymer resin, which solidifies upon transmission from a light source;
providing a receptacle, for containing said photopolymer resin, having a transparent bottom, for allowing an external light source to transmit light into said device for selectively solidifying part of the photopolymer resin into a solidified polymer layer of said contact lens;
providing a detachable top, for covering said receptacle, with an aperture for allowing the flow of fluids into and out of said device;
providing an elevatable platform, located inside said device, serving as a build plate for the solidified layer(s) of said contact lens, wherein said platform elevates said solidified layer(s), of said contact lens, for allowing the solidification of a new layer, of said contact lens;
providing a conduit, where the distal side, of said conduit, is attached to said platform and its proximal side is accessible from without said device, through said aperture in said top, for allowing the flow of fluids into and out of said device and for the elevating of said platform by pulling said conduit and the attached said platform; and
transmitting light into said device for solidifying part of the photopolymer resin into a solidified polymer layer, layer after layer, for forming said contact lens.

13. A method according to claim 12, where the contact lens is inspected using at least one camera, to ensure the quality of the contact lens.

14. A method according to claim 12, where the contact lens is washed by Buffered Saline or alcohol.

15. A method according to claim 12, where a preservation solution is added to the receptacle for preserving the contact lens.
